(19) United States
(12) Patent Application Publication
(10) Pub. No.: US 2002/0026643 A1
(43) Pub. Date: Feb. 28, 2002

(54) Data transmission system and method

(76) Inventors: Henry Ewen, Maitland, FL (US); Mario Pino, Longwood, FL (US)

Correspondence Address: BAKER & MCKENZIE, 805 THIRD AVENUE, NEW YORK, NY, 10022, US

(21) Appl. No.: 09/854,109

(22) Filed: May 11, 2001

Related U.S. Application Data
(60) Provisional application No. 60/203,889, filed on May 12, 2000.

(51) Int. Cl. H04N 7/173

(52) U.S. Cl. 725/109; 725/111; 725/121

(57) ABSTRACT

A data delivery system including a transmodulator for converting Internet data modulated using a first modulation protocol to Internet data modulated using a second modulation protocol and a receiver for receiving the Internet data modulated using the second modulation protocol via a transmission link.

### CROSS-REFERENCE TO RELATED APPLICATIONS

The present application claims benefit of provisional application No. 60/203,889 filed May 12, 2000.

### FIELD

The present application generally relates to a data transmission system and method and, more particularly, to a system and method for the delivery of Internet data to a modem via a wireless transmission link.

### BACKGROUND INFORMATION

Transmitting Internet data via an asynchronous methodology is well known in the art. Asynchronous delivery of Internet data is common in the Internet industry due to the nature of Internet traffic. Most Internet traffic carried over the Internet is data being sent to end-users in response to data requests made by those end-users. This results in large volumes of data flowing towards end-users while modest amounts of data flow away from end-users. The Internet industry often takes advantage of this fact to reduce costs and maximize utilization of the communication links that comprise the Internet.

Asynchronous is used herein to describe one or more manners of delivering request traffic on one or more routes and delivering response traffic via one or more other routes, whereby the different routes are chosen due to addressing of the data or routing policies contained in certain routers, or other techniques, specifically for the Internet data in question, as opposed to routing differences due to, but not limited to, congestion and other vagaries of the Internet. Therefore, an asynchronous methodology for purposes of this application represents Further, the use of the term asynchronous herein is not related to the usage of the term for Internet communication links that have different upstream rates versus downstream rates.

FIGS. 1 through 4 illustrate four known systems for transmitting Internet data via an asynchronous methodology. Specifically, FIG. 1 illustrates a satellite direct-to-home system 100, FIG. 2 illustrates a one-way cable modem system 200 using an IP encapsulator, FIG. 3 illustrates a one-way cable modem system 300 using a cable modem termination system (“CMTS”), and FIG. 4 illustrates a two-way cable modem system using a CMTS and an asynchronous delivery of bandwidth to the CMTS.

Satellite direct-to-home system 100, shown in FIG. 1, includes end-user 115, uplink facility 105, Internet 120 and satellite 110. Further, uplink facility 105 includes router 125, encapsulator 130, modulator 135 and satellite antenna 140. Up-link facility 105 may also include a network address translation server (“NAT device”) coupled to router 125 for requesting traffic, for readdressing or for proxy functions. End-user 115 includes satellite antenna 145, satellite modem 150, operating system 155 and modem 160.

End-user 115 establishes a connection to Internet 120 using an industry standard analog dial up modem 160. There are a variety of possible ways, however, for an end-user to connect to Internet 120, including using ISDN, DSL, frame relay, a dedicated connection or a very small aperture terminal (“VSAT”). Once a connection is established to Internet 120, a computer, including software such as operating system 155, of the end-user makes a data request or sends a reply via the established connection to Internet 120 using standard and well known industry techniques. Internet 120 includes a number of routers that route the data request to the appropriate destination. The destination provides a response comprised of data and routing information, referred to hereafter as response traffic. The response traffic is routed to router 125 at uplink facility 105. Router 125 forwards the response traffic, with or without intermediary processes, to IP encapsulator 130. IP encapsulator 130 adds additional address information, including address information pertaining to a destination device, onto the response traffic and formats the data into a digital video broadcast (“DVB”) compliant data stream. The DVB compliant data stream is forwarded, with or without intermediary processes, to modulator 135. Modulator 135 receives the DVB complaint data stream and converts the data stream to whichever modulation standard is being used on a transponder of satellite 110, for example, bi phase shift keying (“BPSK”), quadrature phase shift keying (“QPSK”) or eight phase shift keying (“8PSK”). Modulator 135 outputs the modulated data stream through a variety of satellite industry standard devices to uplink satellite antenna 140 in order to get the modulated data stream up to a satellite transponder of satellite 110. The transponder of satellite 110 rebroadcast the data stream so that the data stream is received at satellite antenna 145 of end-user 115. The data stream is then forwarded to satellite modem 150. Satellite modem 150 demodulates the signal and reads the DVB packet information. If the packet is addressed to that satellite modem 150, satellite modem 150 reads the packet and forwards the IP portion of the packet to operating system 155.

FIG. 2 illustrates a one-way cable modem system 200 including an IP encapsulator. System 200 includes end-user 205, Internet 210 and head end 215. Head end 215 includes router 220, IP encapsulator 225, modulator 230 and combiner 235. In addition, head end 215 can also include a NAT device coupled to router 220 for requesting traffic, for readdressing or for proxy functions. End-user 205 includes modem 240, operating system 245 and modem 250.

End user 205 establishes a connection to Internet 210 using an industry standard analog dial up modem 250. There are a variety of possible ways, however, for an end-user to connect to Internet 210, including using ISDN, DSL, frame relay, a dedicated connection or VSAT. Once a connection is established to Internet 210, a computer, including software such as operating system 245, of end-user 205 makes a data request or sends a reply via the established connection to Internet 210 using standard and well known industry techniques. Internet 210 includes a number of routers that route the data request to the appropriate destination. The destination provides a response comprised of data and routing information, referred to hereafter as response traffic. The response traffic is routed to the router 220 at head end 215. Router 220 at head end 215 may be connected to Internet 210 in a variety of manners, including using ISDN, frame relay, a direct connection, or wireless links. Router 220 forwards the response traffic, with or without intermediary process to IP encapsulator 225. IP encapsulator 225 adds additional address information, including address information pertaining to a destination device, onto the response traffic and formats the data into a DVB compliant data stream. The DVB compliant data stream is forwarded, with or without intermediary processes, to modulator 230. Modulator 230 receives the DVB complaint data stream and converts the data stream to whichever modulation standard is being used in the cable system, for example, QAM8, QAM32, QAM64, QAM128 or QAM256. Modulator 230 outputs the now modulated data stream into combiner 235. Combiner 235 combines all the channels in the cable system on specific frequencies for reception by cable subscribers. End-user 205 receives the data stream from combiner 235 via a terrestrial transmission link, for example, a coaxial cable or fiber optic cable, or via a wireless transmission link, such as ultra high frequency (“UHF”) link. The data signal is received by DVB compliant cable modem 240 located at end-user 205. DVB cable modem 240 demodulates the data signal and reads the DVB packet information. If the packet is addressed to modem 240, DVB cable modem 240 reads the packet and forwards the IP portion of the packet to operating system 245.

FIG. 3 illustrates a one-way cable modem system 300 using a CMTS. System 300 includes end-user 305, Internet 315 and head end 320. Head end 320 includes router 325, CMTS 330 and combiner 335. In addition, head end 320 can also include a NAT device coupled to router 320 for requesting traffic, readdressing or proxy functions. End-user 305 includes cable modem 340, operating system 345 and modem 350.

End-user 305 establishes a connection to Internet 315 using an industry standard analog dial up modem 350. There are a variety of possible ways, however, for an end-user to connect to the Internet, including using ISDN, DSL, frame relay, a dedicated connection or VSAT. Once a connection is established to Internet 315, a computer, including software such as operating system 345, of end-user 305 makes a data request or sends a reply via the established connection to Internet 315 using standard and well known industry techniques. Internet 315 includes a number of routers that route the data request to the appropriate destination. The destination provides a response comprised of data and routing information, referred to hereafter as response traffic. The response traffic is routed to router 325 at head end 320. Router 325 at head end 320 may be connected to Internet 315 in a variety of manners, including using ISDN, frame relay, a direct connection or a wireless link. Router 325 forwards the response traffic, with or without intermediary process to CMTS 330. CMTS 330 adds additional address information, including address information pertaining to a destination device, onto the response traffic and formats the data into a data over cable service interface specification (“DOCSIS”) compliant data stream. CMTS 330 modulates the data stream using an appropriate modulation protocol for the cable system to utilize. The DOCSIS compliant modulated data stream is output to combiner 335. Combiner 335 combines all the channels in the cable system on specific frequencies for reception by cable subscribers. End-user 305 receives the data stream from combiner 335 via a terrestrial transmission link, for example, a coaxial cable or fiber optic cable, or via a wireless transmission link, such as UHF or LMDS. The data stream is received at DOCSIS compliant cable modem 340 located at end-user 305. Cable modem 340 demodulates the cable signal and reads the DOCSIS packet information. If the packet is addressed to that cable modem 340, cable modem 340 reads the packet and forwards the IP portion of the packet to operating system 345.

FIG. 4 illustrates a two-way cable modem system 400 including a CMTS. System 400 includes end-user 405, Internet 410, uplink facility 415, satellite 445 and head end 420. Uplink facility 415 includes router 425, encapsulator 430, modulator 435, and satellite antenna 440. Further, head end 420 includes satellite antenna 450, satellite receiver with router and/or NAT device 455 (“satellite receiver”), CMTS 460, and combiner 465. End-user 405 includes cable modem 470 and operating system 475.

End user 405 has a full-time connection to CMTS 460 via DOCSIS complaint cable modem 470 and a transmission link. Since the connection is established in either a proprietary or open standard way, end-user 405 makes a request or sends a reply at any time via the established connection to CMTS 460. CMTS 460 forwards the request to either an internal or external satellite receiver 455 coupled to CMTS 460 via an Ethernet connection. CMTS 460 or satellite receiver 455 modify the addressing information of the request traffic or repackage the request traffic so that a response will be returned via the route designated for response traffic. Satellite receiver 455 routes the request traffic via a transmission link to Internet 410 designated to handle such traffic. For example, routers used in Internet 410 ultimately route the request to the appropriate destination, such as router 425 located at uplink facility 415. A NAT device or proxy device located at uplink facility 415 forwards the request to the appropriate devices in Internet 410. The response is returned via Internet 410 to router 425. The response traffic is routed via encapsulator 430, modulator 435, and transmission link 445 designated for response traffic to satellite receiver 455 at head end 420. Satellite receiver 455 may be connected to Internet 410 in a variety of manners including using ISDN, frame relay, a direct connection or a wireless transmission link. Satellite receiver 455 forwards the response traffic, with or without intermediary processes, to CMTS 460. CMTS 460 adds additional address information, including address information pertaining to a destination device, onto the response traffic and formats the data into a DOCSIS compliant data stream. CMTS 460 modulates the data stream using an appropriate modulation protocol for the cable system to utilize. The DOCSIS compliant modulated data stream is output to combiner 465. Combiner 465 combines all the channels in the cable system on specific frequencies for reception by cable subscribers. End-user 405 receives the data stream from combiner 465 via a transmission link, for example, a coaxial cable. The cable signal is received at DOCSIS compliant cable modem 470 located at end user 405. DOCSIS compliant cable modem 470 demodulates the cable signal and reads the DOCSIS packet information. If the packet is addressed to that DOCSIS cable modem, DOCSIS cable modem 470 reads the packet and forwards the IP portion of the packet to operating system 475.

FIG. 5 illustrates television system 500 wherein television signals are transmitted from a satellite to a head end. System 500 includes end-user 505, uplink facility 510 and head end 515. Uplink facility 510 includes DVB MPEG2 encoder 520, modulator 525 and satellite antenna 530, and head end 515 includes satellite antenna, trans-modulator 545 and combiner 550. In addition, end-user 505 includes television 555.

Trans-modulator 545 is used in the TV industry in order to forward television signals transmitted via satellite through cable systems. Trans-modulators may be one or more pieces in design, for example, a demodulator and one or more modulators.

As shown in FIG. 5, television signal 560 is received at satellite uplink facility 510 where the television signal can be converted into a compressed digital data stream such as DVB MPEG2 by DVB MPEG2 encoder 520. The television signal, whether compressed or not, is input into modulator 525 which converts the data stream to whichever modulation standard is being used on a transponder of satellite 535, for example, BPSK, QPSK or 8PSK. The modulated data stream passes through a variety of devices, not all of which are shown in FIG. 5, to be transmitted via the satellite antenna 530 to the transponder of satellite 535. Satellite 535 rebroadcasts the data stream to satellite antenna 540 at head end 545 or an individual subscriber's satellite antenna. The data stream is forwarded to trans-modulator 545 which converts the data stream modulated using the satellite modulation protocol to a modulated data stream that can be used in a cable system, for example, QAM for terrestrial cable systems or QAM or COFDM for wireless cable systems.

The respective systems shown in FIGS. 1 through 5 can also include more than one end-user and more than one head end.

Moreover, in the systems shown in FIGS. 1 through 5 Internet traffic requires readdressing or packaging by a centralized server such as a Proxy server or a NAT server to properly route the Internet traffic.

There is a need for providing Internet data to modems of end-users via a wireless transmission link without requiring the end-users to have antennas and without requiring head ends to have expensive, hard to manage devices. A need also exist for first routing Internet data responsive to an end-user request to a transmission facility having an associated source address and then transmitting the data to an end-user via a wireless transmission link.

### SUMMARY OF THE INVENTION

An aspect of the present application provides for a data delivery system, including a trans-modulator for converting Internet data modulated using a first modulation protocol to Internet data modulated using a second modulation protocol, and a modem for receiving the Internet data modulated using the second modulation protocol via a transmission link.

Another aspect of the present application provides for a data delivery system, including a modulator for modulating Internet data using a first modulation protocol, a trans-modulator coupled to the modulator via a wireless transmission link for converting the Internet data modulated using the first modulation protocol to Internet data modulated using a second modulation protocol, the trans-modulator being located at a head end, and a modem for receiving the Internet data modulated using the second modulation protocol via a transmission link.

A further aspect of the present application provides for a data delivery system, including a first modem for transmitting a data request via the Internet, at least one server in the Internet for retrieving data responsive to the data request, an encapsulator for receiving the responsive data from the Internet and for generating encapsulated data, a modulator coupled to the encapsulator for receiving the encapsulated data and for generating modulated data using a first modulation protocol, a wireless transmitter for transmitting the modulated data via a wireless transmission link, an antenna for receiving the modulated data transmitted via the wireless transmission link, a trans-modulator coupled to the antenna for converting the modulated data to data modulated using a second modulation protocol, and a second modem coupled to the trans-modulator for receiving data modulated using the second modulation protocol via a transmission link.

A still further aspect of the present invention includes a data delivery method, including modulating Internet data using a first modulation protocol, transmitting the Internet data modulated using the first modulation protocol via a wireless transmission link to a head end, converting at the head end the Internet data modulated using the first modulation protocol into Internet data modulated using a second modulation protocol, and transmitting the Internet data modulated using the second modulation protocol via a transmission link to a modem.

A still further aspect of the present application provides for a method for routing Internet response data in an asynchronous data transmission system, including authenticating a device of an end-user, forwarding an IP source address associated with a transmission facility to the end-user device upon authentication, and receiving the Internet response data responsive to a data request of the end-user at the transmission facility.

### BRIEF DESCRIPTION OF THE DRAWINGS

FIG. 1 illustrates a system having a satellite signal transmitted directly to a home;

FIG. 2 illustrates a one-way cable modem system including an IP encapsulator;

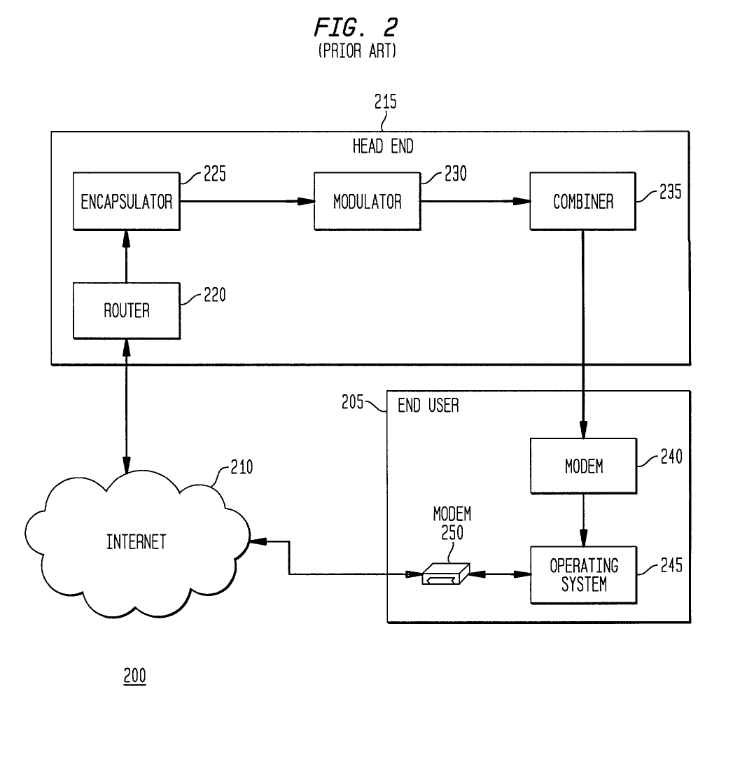

FIG. 3 illustrates a one-way cable modem system including a cable modem termination system;

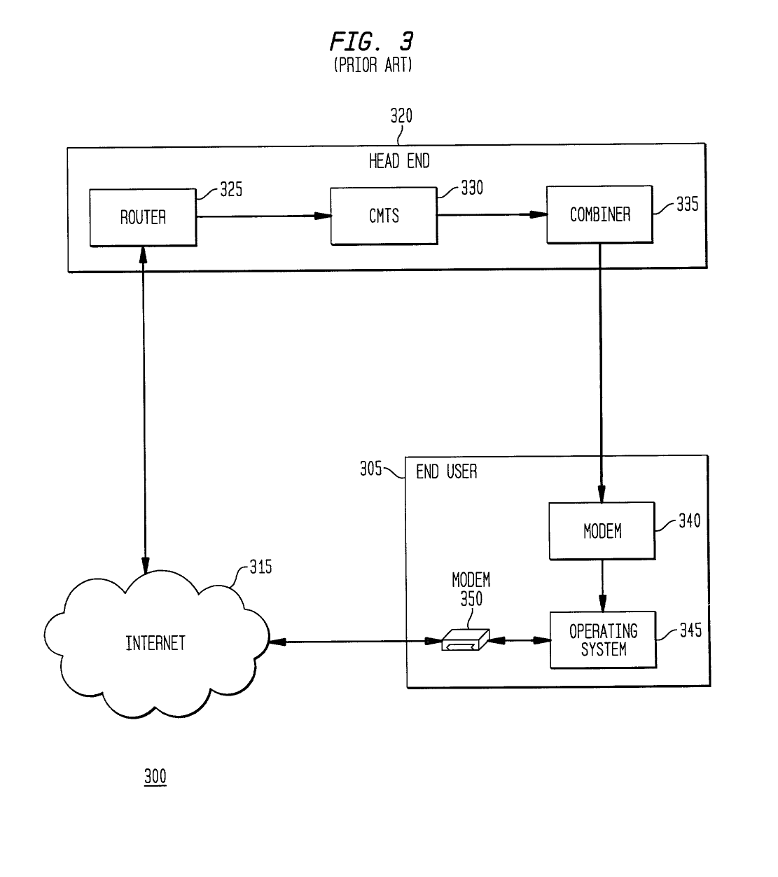

FIG. 4 illustrates a two-way cable modem system including a cable modem termination system;

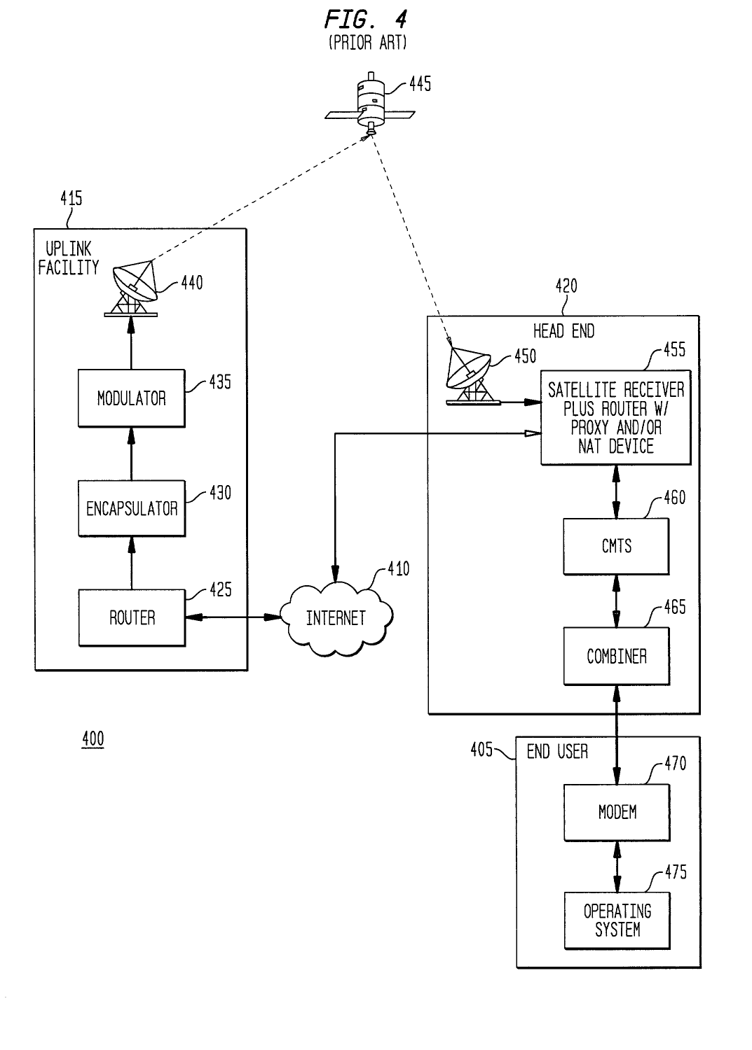

FIG. 5 illustrates a cable television system including a trans-modulator;

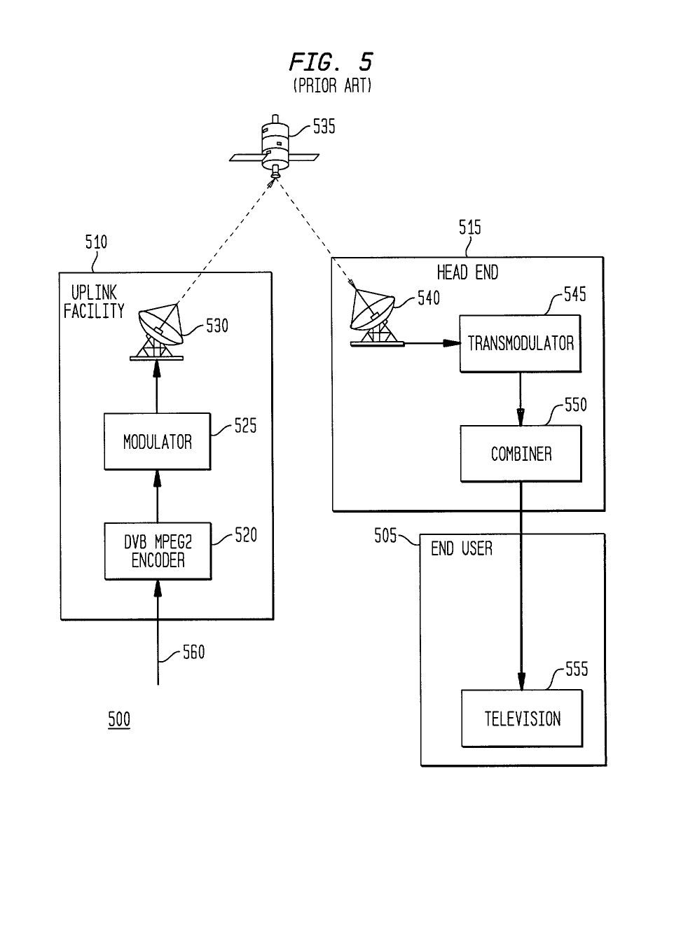

FIG. 6 illustrates an exemplary data transmission system of the present application; and

FIG. 7 illustrates an exemplary method of addressing Internet data.

### DETAILED DESCRIPTION

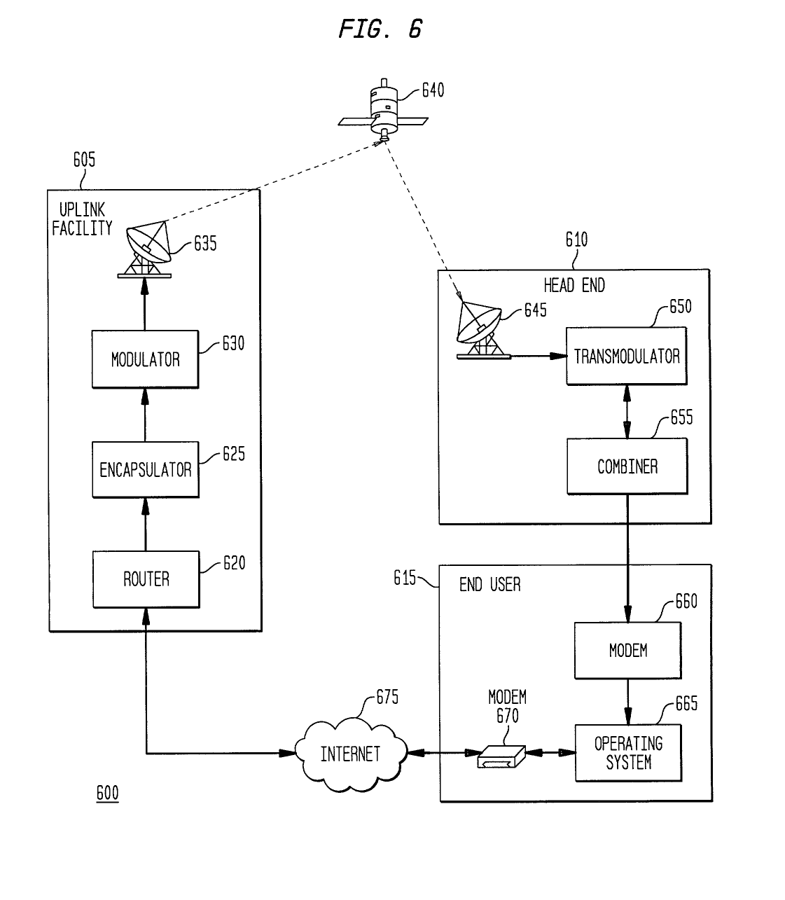

FIG. 6 illustrates an exemplary data transmission system 600 of the present application. Data transmission system 600 includes end-user 615, uplink facility 605, head end 610, Internet 675 and satellite 640. Further, uplink facility 605 includes, for example, one or more routers 620, one or more encapsulators 625, one or more modulators 630 and one or more wireless transmitters 635, for example, a satellite antenna. Head end 610 includes antenna 645, for example, a satellite antenna, trans-modulator 650 and combiner 655, and end-user 615 includes modem 660, for example, a DVB complaint cable modem, operating system 665 and modem 670. In alternative embodiments, more than one end-user and/or more than one head end can be included in data transmission system 600.

Head end 610 can be coupled to end-user 615 via a terrestrial or wireless transmission link and can be, for example, a head end of a cable system servicing one or more locations. Cable systems referred to hereafter may transmit data signals and/or television signals via wire or wireless transmission link. In addition, head end 610 can be a terrestrial head end or a wireless head end. Examples of terrestrial head ends include a cable television head end, a private cable operator head end, a multiple dwelling unit head end and a single master antenna television system head end. Examples of wireless head ends are a very high frequency head end, an ultra high frequency head end, a multipoint, multi-channel distribution system head end and a low power microwave distribution system head end.

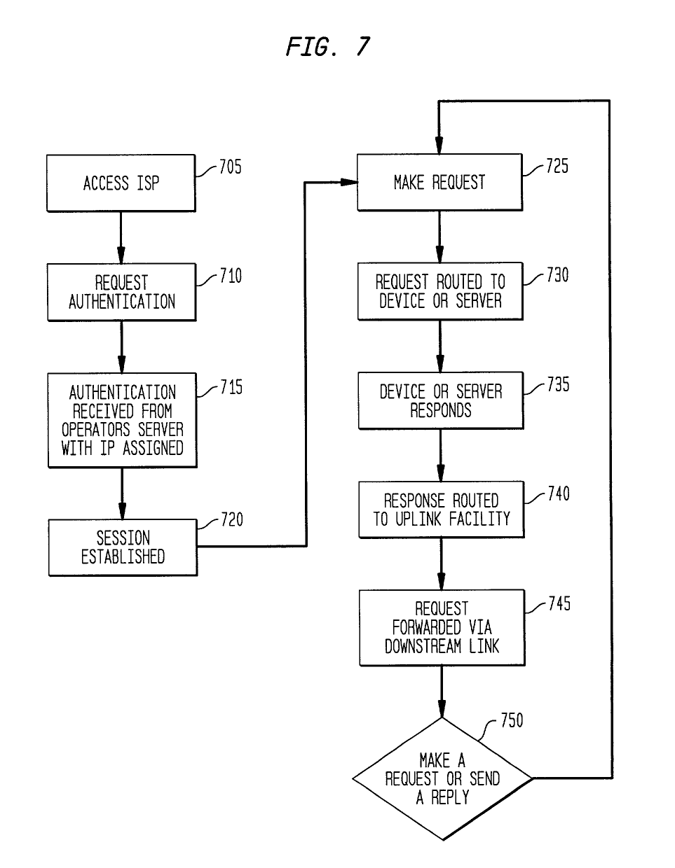

In data transmission system 600, end user 615 establishes a connection to Internet 675 using an industry standard analog dial up modem 670. There are a variety of possible ways, however, for an end-user to connect to Internet 675, including, but not limited to, using ISDN, DSL, frame relay, a dedicated connection or VSAT. Once a connection is established to the Internet 675, a computer, including software such as operating system 665, of end-user 615 makes a data request or sends a reply via the established connection to Internet 675, for example, using a tunneling technique. The embodiment described with reference to FIG. 7 can be also be used as opposed to the tunneling technique. Internet 675 includes a number of routers, not shown in FIG. 6, that route the data request to the appropriate destination. For example, when using a tunneling technique, the initial destination could be a proxy server or NAT device, nor shown in FIG. 6. Such device can be located at uplink facility 605. The proxy server or NAT device addresses the data request or reply to the appropriate destination replacing the original end user 615 return IP address with the proxy server's or NAT device's return IP address. The destination provides a response comprised of data and routing information, referred to hereafter as response traffic. The response traffic is routed to the return address provided on the data request or reply which is router 620 at uplink facility 605.

Router 620 forwards the response traffic, with or without intermediary processes, to IP encapsulator 625. IP encapsulator 625 adds additional address information, including address information pertaining to a destination device, for example, DVB complaint cable modem 660, onto the response traffic and formats the data into a DVB compliant data stream. In alternative embodiments, the data stream may be formatted in other transmissible manners. Thus, all references to the DVB format is merely illustrative. The DVB compliant data stream is forwarded, with or without intermediary processes, to modulator 630. Modulator 630 receives the DVB complaint data stream and converts the data stream into the first of two modulation protocols. The first modulation protocol is used to transmit the data stream via a transponder of satellite 610. For example, the first modulation protocol can be BPSK, QPSK or 8PSK.

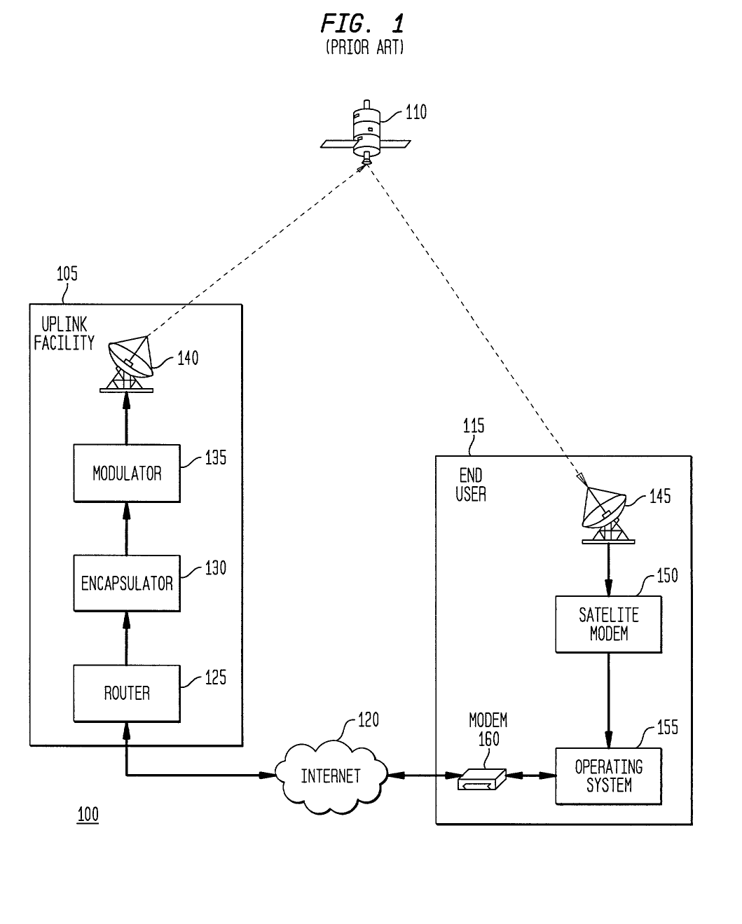

Modulator 630 outputs the modulated data stream to wireless transmitter 635, for example a satellite antenna. Wireless transmitter 635 transmits the modulated data stream to a satellite transponder of satellite 640. The transponder of satellite 640 rebroadcasts the data stream so that the data stream is received at antenna 645 located at head end 610. Alternatively, the transmitted data stream can be received at satellite antenna 145 located at end-user 115, shown in FIG. 1. Other wireless transmission links and associated devices can be utilized as well. Thus, the use of a satellite, a satellite transmission link and satellite antennas are merely illustrative.

The data stream is forwarded to trans-modulator 650. Trans-modulator 650 converts the data stream modulated with the first modulation protocol used by satellite 640 to a data stream modulated with a second modulation protocol that can be used by a wireless or terrestrial cable system. For example, if the data stream was transmitted via satellite 640 using QPSK modulation, trans-modulator 650 can convert the data stream to a QAM modulated data stream. These two modulation protocols are merely illustrative and therefore any other combination of modulation protocols can be utilized as well. Trans-modulators may be one or more pieces in design, for example, a demodulator and one or more modulators coupled together.

Trans-modulator 650 outputs the modulated data stream directly to combiner 655 or via one or more other devices. Combiner 655, for example, combines all the channels in the cable system on specific frequencies for reception by cable subscribers.

End-user 615 receives the data stream from combiner 235 via a terrestrial transmission link, for example, a coaxial cable or fiber optic cable, or via a wireless transmission link, such as a UHF link. The modulated data stream is received at modem 660 located at end-user 615. Modem 660 demodulates the data stream and reads the packet information, for example, DVB packet information. If the packet is addressed to modem 660, modem 660 reads the packet and forwards the IP portion of the packet to operating system 665.

Thus, data transmission system 600 enables an asynchronous, geographically dispersed, terrestrial and/or wireless Internet data system.

FIG. 7 illustrates an exemplary method of addressing Internet data so that Internet data is not returned to the originating device or computer, but rather redirected to another device or computer.

An end-user first accesses an Internet service provider (“ISP”), in 705, and requests authentication, in 710. In an exemplary embodiment, the ISP has an arrangement with an operator of, for example, system 600. The arrangement requires that for end-users that intend to utilize system 600 and connect to ISP, authentication of those end-users is from one or more authentication servers of the operator via one or more ISP authentication servers, for example, proxy radius. Other protocols, software or systems and can be used as well.

Upon authentication, the authentication server of the operator forwards an IP address from, for example, the operator's pool of IP addresses to the ISP authentication server. The ISP authentication server forwards the IP address from the authentication server of the operator to a user device or computer as the IP address to use for the current session, in 715. The end-user's device or computer will use the forwarded IP address as the end-user's device or computers source address for the current session. The IP address assigned to the end-user by the authentication server of the operator results in data responses to be routed, for example, to encapsulator 625, shown in FIG. 6. Data responses can be routed to any type of transmission facility.

By redirecting Internet traffic, for example, in systems shown in FIGS. 1 and 6, versus using, for example, a tunneling technique, latency, cost and/or hardware requirements may be reduced.

Once the current session is established, in 720, the end-user makes a request or response, referred to hereafter as request traffic, in 725. The data request is routed as a synchronous request to the destination device or server, for example, www.CNN.com, in 730. Destination device or server responds and addresses the response to the source IP address, referred to hereafter as response traffic, in 735. Response traffic is routed via Internet 675 to a transmission facility, for example, a satellite uplink facility 605 and eventually to encapsulator 625, in 740. Response traffic is thereafter forwarded via an asynchronous downstream link, such as a wireless transmission link, to an end-user connected to such a link, in 745. The end-user can thereafter make another request or send a reply, in 750.

The embodiments described above are illustrative examples of the present injention and it should not be construed that the present invention is limited to these particular embodiments. Various changes and modifications may be effected by one skilled in the art without departing from the spirit or scope of the invention as defined in the appended claims.

What is claimed is:

1. A data delivery system, comprising:
a trans-modulator for converting Internet data modulated using a first modulation protocol to Internet data modulated using a second modulation protocol; and
a modem for receiving the Internet data modulated using the second modulation protocol via a transmission link.

2. The data deliverer system as set forth in claim 1, wherein
the trans-modulator is located at a wireless head end or a terrestrial head end.

3. The data delivery system as set forth in claim 2, wherein
the terrestrial head end includes a cable television head end, a private cable operator head end, a multiple dwelling unit head end or a single master antenna television system head end.

4. The data delivery system as set forth in claim 2, wherein the
wireless head end is a very high frequency head end, an ultra high frequency head end, a multipoint, multi-channel distribution system head end or a low power microwave distribution system head end.

5. The data delivery system as set forth in claim 1, wherein
the first modulation protocol is quadrature phase shift keying modulation.

6. The data delivery system as set forth in claim 1, wherein
the first modulation protocol is eight phase shift keying modulation.

7. The data delivery system as set forth in claim 1, wherein
the second modulation protocol is quadrature amplitude modulation.

8. The data delivery system as set forth in claim 1, wherein
the second modulation protocol is coded orthogonal frequency division multiplexing.

9. A data delivery system, comprising:
a modulator for modulating Internet data using a first modulation protocol;
a trans-modulator coupled to the modulator via a wireless transmission link for converting the Internet data modulated using the first modulation protocol to Internet data modulated using a second modulation protocol, the trans-modulator or being located at a head end; and
a modem for receiving the Internet data modulated using the second modulation protocol via a transmission link.

10. The system as set forth in claim 9, wherein
the wireless transmission link is a satellite transmission link.

11. The system as set forth in claim 9, wherein
the head end is a wireless head end or terrestrial head end.

12. The system as set forth in claim 9, wherein
the terrestrial head end includes a cable television head end, a private cable operator head end, a multiple dwelling unit head end or a single master antenna television system head end.

13. The data delivery system as set forth in claim 9, wherein
the wireless head end is a very high frequency head end, an ultra high frequency head end, a multipoint, multi-channel distribution system head end or a low power microwave distribution system head end.

14. The system as set forth in claim 9, wherein
the modem is a quadrature amplitude modulation modem.

15. The system as set forth in claim 9, wherein
the first modulation protocol is quadrature phase shift keying modulation.

16. The system as set forth in claim 9, wherein
the first modulation protocol is eight quadrature phase shift keying modulation.

17. The system as set forth in claim 9, wherein
the second modulation protocol is quadrature amplitude modulation.

18. A data delivery system, comprising:
a first modem for transmitting a data request via the Internet;
at least one server in the Internet for retrieving data responsive to the data request;
an encapsulator for receiving the responsive data from the Internet and for generating encapsulated data;
a modulator coupled to the encapsulator for receiving the encapsulated data and for generating modulated data using a first modulation protocol;
a wireless transmitter for transmitting the modulated data via a wireless transmission link;
an antenna for receiving the modulated data transmitted via the wireless transmission link;
a trans-modulator coupled to the antenna for converting the modulated data to data modulated using a second modulation protocol; and
a second modem coupled to the trans-modulator for receiving data modulated using the second modulation protocol via a transmission link.

19. The data delivery system as set forth in claim 18, wherein
a computer coupled to the first modem is assigned an IP source address associated with the encapsulator before transmitting the data request so that the data responsive to the data request is transmitted to the encapsulator.

20. The data delivery system as set forth in claim 18, wherein
the first modem is a quadrature amplitude modulation modem.

21. The data delivery system as set forth in claim 18, wherein
the second modem is an analog dial up modem.

22. The data delivery system as set forth in claim 18, wherein
the first modulation is protocol is quadrature phase shift keying modulation.

23. The data delivery system as set forth in claim 18, wherein
the first modulation protocol is eight quadrature phase shift keying modulation.

24. The data delivery system as set forth in claim 18, wherein
the second modulation protocol is quadrature amplitude modulation.

25. A data delivery method, comprising:
modulating Internet data using a first modulation protocol;
transmitting the Internet data modulated using the first modulation protocol via a wireless transmission link to a head end;
converting at the head end the Internet data modulated using the first modulation protocol into Internet data modulated using a second modulation protocol; and
transmitting the Internet data modulated using the second modulation protocol via a transmission link to a modem.

26. The data delivery method as set forth in claim 25, wherein
the first modulation protocol is quadrature phase shift keying modulation.

27. The data delivery system as set forth in claim 25, wherein
the first modulation protocol is eight quadrature phase shift keying modulation.

28. The data delivery method as set forth in claim 25, wherein
the second modulation protocol is quadrature amplitude modulation.

28. A method for routing Internet response data in an asynchronous data transmission system, comprising:
authenticating a device of an end-user;
forwarding an IP source address associated with a transmission facility to the end-user device upon authentication; and
receiving the Internet response data responsive to a data request of the end-user at the transmission facility.

29. The method for routing Internet response data as set forth in claim 28, further comprising:
modulating the Internet response data in order to transmit the Internet response data over a wireless transmission link.

30. The method for routing Internet response data as set forth in claim 28, wherein
the transmission facility is a satellite uplink facility.

31. The method for routing Internet response data as set forth in claim 29, wherein
the wireless transmission link is a satellite transmission link.

32. The method for routing Internet response data as set forth in claim 28, further comprising:
modulating the Internet response data using a first modulation protocol;
converting the Internet response data modulated using the first modulation protocol into Internet response data modulated using a second modulation protocol; and
transmitting the Internet response data modulated using the second modulation protocol to an end-user via a transmission link.
